(19) United States
(12) Patent Application Publication
(10) Pub. No.: US 2026/0265561 A1
(43) Pub. Date: Sep. 10, 2026

(54) ACTIVE ENERGY RAY CURABLE INKJET INK SET, INKJET INK RECORDING METHOD, AND PRINTED MATTER

(71) Applicants: Hiroki KOBAYASHI, Kanagawa (JP); Tomohiro NAKAGAWA, Kanagawa (JP); Yuka AOYAMA, Kanagawa (JP); Daiki HYAKUTAKE, Kanagawa (JP)

(72) Inventors: Hiroki KOBAYASHI, Kanagawa (JP); Tomohiro NAKAGAWA, Kanagawa (JP); Yuka AOYAMA, Kanagawa (JP); Daiki HYAKUTAKE, Kanagawa (JP)

(21) Appl. No.: 19/542,941

(22) Filed: Feb. 18, 2026

(30) Foreign Application Priority Data
Mar. 6, 2025 (JP) 2025-035289

(51) Int. Cl. C09D 11/40; B41M 3/00; B41M 7/00; C09D 11/101

(52) U.S. Cl. CPC C09D 11/40; B41M 3/008; B41M 7/0081; C09D 11/101

(57) ABSTRACT

An active energy ray curable inkjet ink set is provided that includes a white ink and a colored ink. The white ink contains a photopolymerizable compound containing a monofunctional photopolymerizable compound in an amount of 50% by mass or more and 90% by mass or less of the photopolymerizable compound contained in the white ink, and a photopolymerization initiator. The colored ink contains a photopolymerizable compound, a photopolymerization initiator, a color material, and a gelling agent.

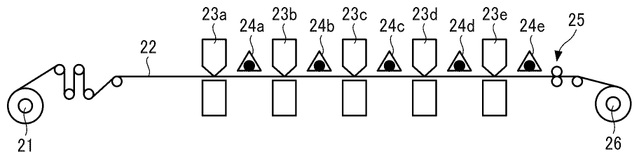

### CROSS-REFERENCE TO RELATED APPLICATION

This patent application is based on and claims priority pursuant to 35 U.S.C. § 119(a) to Japanese Patent Application No. 2025-035289, filed on Mar. 6, 2025, in the Japan Patent Office, the entire disclosure of which is hereby incorporated by reference herein.

### BACKGROUND

### Technical Field

The present disclosure relates to an active energy ray curable inkjet ink set, an inkjet ink recording method, and printed matter.

### Related Art

An inkjet ink recording method is a recording method in which ink droplets are ejected from an extremely fine nozzle and deposited on a recording medium to form a character and an image. Such a method has been widely used in recent years because it is easier to achieve full color than other recording methods and the method has the advantage that high-resolution images can be obtained even with a device having a simple configuration.

### SUMMARY

Embodiments of the present disclosure provides an active energy ray curable inkjet ink set that includes a white ink and a colored ink. The white ink contains a photopolymerizable compound containing a monofunctional photopolymerizable compound in an amount of 50% by mass or more and 90% by mass or less of the photopolymerizable compound contained in the white ink, and a photopolymerization initiator. The colored ink contains a photopolymerizable compound, a photopolymerization initiator, a color material, and a gelling agent.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawing, wherein:
the drawing is a schematic diagram illustrating an image forming apparatus according to an embodiment of the present disclosure.

The accompanying drawing is intended to depict embodiments of the present disclosure and should not be interpreted to limit the scope thereof. The accompanying drawing is not to be considered as drawn to scale unless explicitly noted. Also, identical or similar reference numerals designate identical or similar components throughout the several views.

### DETAILED DESCRIPTION

In describing embodiments illustrated in the drawing, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawing, embodiments of the present disclosure are described below. As used herein, the singular forms “a”, “an”, and “the” are intended to include the plural forms as well, unless the context clearly indicates otherwise.

According to one aspect of the present disclosure, an active energy ray curable inkjet ink set is provided by which the adhesion of a white ink to a recording medium, the gloss of printed matter, and the color development of a colored ink can be improved, and also bleeding of the colored ink can be suppressed, in performing printing with the active energy ray curable inkjet ink on a recording medium.

Hereinafter, embodiments of the present disclosure will be described in detail. In the present specification, unless otherwise specified, the use of “to” to indicate a range of values means that the range includes the values before and after the “to” as the lower and upper limits.

### [Active Energy Ray Curable Inkjet Ink Set]

An active energy ray curable inkjet ink set according to an embodiment of the present disclosure includes a white ink and a colored ink.

### <Active Energy Ray>

Active energy rays used to cure the active energy ray curable inkjet ink of the present disclosure are not particularly limited, and may be any rays that can impart energy necessary to promote a polymerization reaction of a polymerizable component in an inkjet ink, such as ultraviolet rays, as well as electron beams, α-rays, β-rays, γ-rays, or X-rays. Particularly when using a light source having high energy, the polymerization reaction can proceed without using a polymerization initiator. In a case of ultraviolet irradiation, mercury-free devices are strongly desired from the viewpoint of environmental protection, and replacement with GaN-based semiconductor ultraviolet light-emitting devices are extremely useful from both an industrial and environmental perspective. Ultraviolet light emitting diodes (UV-LEDs) and ultraviolet laser diodes (UV-LDs) are small, have a long life, are highly efficient, and are low cost, and thus, are preferable as ultraviolet light sources.

### (White Ink)

A white ink contains at least a photopolymerizable compound and a photopolymerization initiator, and may optionally further contain other components such as a color material and an organic solvent.

One of the features of the white ink is that the content of a monofunctional photopolymerizable compound in the white ink is 50% by mass or more and 90% by mass or less with respect to the total amount of the photopolymerizable compound contained in the white ink. This improves the adhesion to a recording medium such as a printing film and the response to deformation, and thus, it is possible to improve the robustness of the printed matter.

The white ink according to an embodiment of the present disclosure is preferably substantially free of a gelling agent. This makes it possible to improve the leveling properties of the white ink from the time the white ink is printed on a recording medium such as a film until the white ink is cured by irradiation with active energy rays to improve adhesion to the recording medium such as a film, and the gloss and the color development of the colored ink. It is noted that “substantially free of” a gelling agent preferably means that the content is less than 0.1% by mass.

It is preferable that the white ink according to an embodiment of the present disclosure has a difference between the dynamic surface tension at 25° C. for 15 milliseconds (ms) and the dynamic surface tension at 25° C. for 1,500 ms of 0 mN/m or more and 3.0 mN/m or less. This makes it possible to improve the wettability of the colored ink to form a color image with a smooth surface, high gloss, and high color development.

In the present disclosure, there are no particular limitations on a method for measuring the dynamic surface tension of ink, and the dynamic surface tension can be measured using a known device, for example, a portable dynamic surface tension meter, Dynotester (Yamato Scientific Co., Ltd.).

### (Colored Ink)

A colored ink contains at least a photopolymerizable compound, a photopolymerization initiator, a color material, and a gelling agent, and optionally further contains other components such as an organic solvent.

One of the characteristics of the colored ink is that the colored ink contains a color material and a gelling agent. This makes it possible to prevent adjacent impact dots from mixing with each other in high-speed one-pass film printing to obtain an image without bleeding.

It is preferable that the colored ink according to an embodiment of the present disclosure has a difference between the dynamic surface tension at 25° C. for 15 ms and the dynamic surface tension at 25° C. for 1,500 ms of 0 mN/m or more and 3.0 mN/m or less. This makes it possible to improve the wettability of the colored ink to form a color image with a smooth surface, high gloss, and high color development.

### <Monofunctional Photopolymerizable Compound>

A monofunctional photopolymerizable compound (hereinafter may be referred to as “monofunctional monomer”) used in the white ink or the colored ink is a polymerizable compound, among photopolymerizable compounds, that contains, in the molecule, one molecular structure that undergoes a radical polymerization reaction when irradiated with active energy rays.

A monofunctional monomer is not particularly limited and can be appropriately selected depending on the purpose. Examples of the monofunctional monomer include, but are not limited to, phenoxyethyl acrylate, cyclic trimethylolpropane formal acrylate, isobornyl acrylate, acryloylmorpholine, N-vinylcaprolactam, and 2-(2-vinyloxyethoxy)ethyl acrylate. These may be used alone or in combination of two or more types.

The content of the monofunctional monomer in the white ink is not particularly limited as long as the content is 50% by mass or more and 90% by mass or less relative to the total amount of the photopolymerizable compounds contained in the white ink, and can be selected appropriately depending on the purpose. However, 60% by mass or more and 90% by mass or less is preferable, 70% by mass or more and 90% by mass or less is more preferable, and 80% by mass or more and 85% by mass or less is particularly preferable. When the content is 50% by mass or more and 90% by mass or less, the cure shrinkage during the radical polymerization reaction is small, and thus, the adhesion of the white ink to the recording medium is improved.

The content of the monofunctional monomer in the colored ink is not particularly limited and can be selected appropriately depending on the purpose. For example, the content may be 0% by mass or more and 90% by mass or less relative to the total amount of the photopolymerizable compound contained in the colored ink.

<Photopolymerizable Compounds Other than Monofunctional Monomers>

The photopolymerizable compounds other than the monofunctional monomers used in the white ink or the colored ink (hereinafter, may be referred to as “other polymerizable compounds”) are not particularly limited and can be appropriately selected depending on the purpose, and examples of the photopolymerizable compounds include, but are not limited to, a polyfunctional monomer and an oligomer. These may be used alone or in combination of two or more types.

The polyfunctional monomer is not particularly limited and can be appropriately selected depending on the purpose. Examples of the polyfunctional monomer include, but are not limited to, polyethylene glycol (400) diacrylate, polyethylene glycol (600) diacrylate, tripropylene glycol triacrylate, trimethylolpropane (EO) 9 triacrylate, trimethylolpropane (PO) 3 triacrylate, and dipropylene glycol diacrylate. These may be used alone or in combination of two or more types.

The oligomer is not particularly limited and can be appropriately selected depending on the purpose. Examples of the oligomer include, but are not limited to, CN963J85 and CN2273 manufactured by Sartomer Corporation. These may be used alone or in combination of two or more types.

The content of the other polymerizable compounds in the white ink is not particularly limited and can be selected appropriately depending on the purpose. For example, the content may be 0% by mass or more and 30% by mass or less relative to the total amount of the photopolymerizable compound contained in the white ink.

The content of the other polymerizable compounds in the colored ink is not particularly limited and can be selected appropriately depending on the purpose. For example, the content may be 50% by mass or more and 100% by mass or less relative to the total amount of the photopolymerizable compound contained in the colored ink.

### <Surfactant>

The white ink or the colored ink may optionally contain a surfactant. In the present disclosure, the surfactant means a compound having surface activity, excluding so-called “pigment dispersants”.

The surfactant is not particularly limited and can be appropriately selected depending on the purpose, and an example of the surfactant includes, but is not limited to, silicone surfactants. The surfactant may be used alone or in combination of two or more types.

The silicone surfactant is not particularly limited and can be appropriately selected depending on the purpose. Examples of the silicone surfactant include, but are not limited to, BYK302, BYK307, BYK327, BYK331, BYK332, and BYK333 manufactured by BYK Japan Co., Ltd., and TEGO Wet 270 manufactured by Evonik.

The content of the surfactant in the white ink or the colored ink is not particularly limited and can be selected appropriately depending on the purpose, but is preferably 0.01% by mass or more and 2.0% by mass or less relative to the total amount of the ink. When the white ink or the colored ink is substantially free of surfactants, a difference between the dynamic surface tension of the ink for 15 ms at 25° C. and the dynamic surface tension for 1,500 ms at 25° C. can be set to 0 mN/m or more and 3.0 mN/m or less. This makes it possible to improve the leveling properties of the colored ink, and also improve the color development and the gloss.

### <Gelling Agent>

The colored ink contains a gelling agent that can cause the ink to undergo a reversible sol-gel phase transition.

A gel is a structure in which substances lose the independent movement thereof and become aggregated due to interactions such as lamellar structures, polymer networks formed by non-covalent bonds or hydrogen bonds, polymer networks formed by physical aggregation, and aggregated structures of fine particles, and interactions between precipitated microcrystals. Gelling refers to solidification, semi-solidification, or thickening accompanied by a sudden increase in viscosity or elasticity.

In the present disclosure, the phrase “reversibly undergoing sol-gel phase transition depending on a temperature” means that a material can reversibly transition (convert) mutually between a sol state, which has low viscosity and high fluidity and exhibits liquid-like properties, and a gel state, which has high viscosity and exhibits solid or semi-solid properties, depending on change in temperature.

The “sol-gel phase transition temperature” refers to the temperature at which a material changes (transitions) from a sol state to a gel state. Such a term is synonymous with the terms gel transition temperature, gel melting temperature, gel softening temperature, sol-gel transition point, and gel point.

The sol-gel transition temperature of the ink according to an embodiment of the present disclosure is not particularly limited and can be appropriately selected depending on the purpose, but is preferably within the range of 30° C. to 100° C. to improve the ejection stability. The sol-gel transition temperature of the ink according to an embodiment of the present disclosure is preferably between the temperature of the ink in the inkjet recording head and the temperature of the recording medium.

The sol-gel transition temperature can be measured, for example, by placing a gel-like test piece on a heat plate, heating the heat plate, and measuring the temperature at which the shape of the test piece collapses, and such a temperature can be determined as the sol-gel phase transition temperature. The sol-gel transition temperature can also be measured using a commercially available viscoelasticity measuring device (for example, the viscoelasticity measuring device MCR300 manufactured by Physica).

The content of the gelling agent in the colored ink according to one embodiment of the present disclosure is not particularly limited and can be selected appropriately depending on the purpose. However, to satisfactorily suppress the sol-gel phase transition and blooming, the content is preferably 0.5% to 3.5% by mass relative to the total mass of the ink, and more preferably 0.7% to 3.0% by mass.

The gelling agent is not particularly limited and can be appropriately selected depending on the purpose, and examples of the gelling agent include, but are not limited to, dilignoceryl ketone, dibehenyl ketone, distearyl ketone (melting point 84° C.), dieicosyl ketone, dipalmityl ketone (melting point 80° C.), dimyristyl ketone, dilauryl ketone (melting point 68° C.), lauryl myristyl ketone, lauryl palmityl ketone, myristyl palmityl ketone, myristyl stearyl ketone, myristyl behenyl ketone, palmityl stearyl ketone, palmityl behenyl ketone, stearyl behenyl ketone, behenyl behenate (melting point 70° C.), icosyl icosanoate, behenyl stearate (melting point 70° C.), stearyl stearate (melting point 60° C.), palmityl stearate, lauryl stearate, cetyl palmitate (melting point 54° C.), stearyl palmitate, myristyl myristate (melting point 43° C.), cetyl myristate (melting point 50° C.), octyldodecyl myristate, stearyl oleate, stearyl erucate, stearyl linoleate, behenyl oleate, myricyl cerotenate, stearyl montanate, behenyl montanate, arachidyl linoleate, palmityl triacontanoate, and lignoceryl lignocerate.

Examples of commercially available gelling agents include 10-Nonadecane (manufactured by Tokyo Chemical Industry Co., Ltd.), 12-Tricosane (manufactured by Tokyo Chemical Industry Co., Ltd.), 16-Hentriacontanone (manufactured by Tokyo Chemical Industry Co., Ltd.), 18-Pentatriaconone (manufactured by Alfa Aeser), Hentriacontan-16-on (manufactured by Alfa Aeser), KAO wax T1 (manufactured by Kao Corporation), Unistar M-2222SL (manufactured by NOF Corporation), EXCEPARL SS (manufactured by Kao Corporation, Melting point 60° C.), EMALEXCC-18 (manufactured by Nippon Emulsion Co., Ltd.), Amleps PC (manufactured by Kokyu Alcohol Kogyo Co., Ltd.), EXCEPARL MY-M (manufactured by Kao Corporation), SPERM ACETY (manufactured by NOF Corporation), EMALEXCC-10 (manufactured by Nippon Emulsion Co., Ltd.), SS-EMALEX EG-di-S (manufactured by Nippon Emulsion Co., Ltd.), and POEM B-100 (manufactured by Riken Vitamin Co., Ltd.). These commercially available products are often mixtures including two or more types of materials, and thus, may be optionally separated and purified.

Any known gelling agent other than those mentioned above can also be employed for the gelling agent.

Examples of the gelling agent include aliphatic ketone compounds; aliphatic ester compounds; petroleum waxes such as paraffin wax, microcrystalline wax, and petrolactam; vegetable waxes such as candelilla wax, carnauba wax, rice wax, Japan wax, jojoba oil, jojoba solid wax, and jojoba ester; animal waxes such as beeswax, lanolin, and spermaceti; mineral waxes such as montan wax and hydrogenated wax; hydrogenated castor oil or hydrogenated castor oil derivatives; modified waxes such as montan wax derivatives, paraffin wax derivatives, microcrystalline wax derivatives, or polyethylene wax derivatives; higher fatty acids such as behenic acid, arachidic acid, stearic acid, palmitic acid, myristic acid, lauric acid, oleic acid, and erucic acid; higher alcohols such as stearyl alcohol and behenyl alcohol; hydroxystearic acids such as 12-hydroxystearic acid; 12-hydroxystearic acid derivatives; fatty acid amides such as lauric acid amide, stearic acid amide, behenic acid amide, oleic acid amide, erucic acid amide, ricinoleic acid amide, and 12-hydroxystearic acid amide (for example, the Nikkaamide series manufactured by Nippon Kasei Co., Ltd., the ITOWAX series manufactured by Ito Oil Mills, and the FATTYAMID series manufactured by Kao Corporation); N-substituted fatty acid amides such as N-stearyl stearic acid amide and N-oleyl palmitic acid amide; special fatty acid amides such as N,N′-ethylenebisstearylamide, N,N′-ethylenebis-12-hydroxystearylamide, and N,N′-xylylenebisstearylamide; higher amines such as dodecylamine, tetradecylamine, and octadecylamine; fatty acid ester compounds such as stearyl stearic acid, oleyl palmitic acid, glycerin fatty acid ester, sorbitan fatty acid ester, propylene glycol fatty acid ester, ethylene glycol fatty acid ester, and polyoxyethylene fatty acid ester (for example, the EMALLEX series manufactured by Nippon Emulsion Co., Ltd., the RIKEMAL series manufactured by Riken Vitamin Co., Ltd., the POEM series manufactured by Riken Vitamin Co., Ltd., and the like); esters of sucrose fatty acids such as sucrose stearic acid and sucrose palmitic acid (for example, the RYOTO Sugar Ester series manufactured by Mitsubishi Chemical Foods Co., Ltd.); synthetic waxes such as polyethylene wax and α-olefin maleic anhydride copolymer wax (for example, the UNILIN series manufactured by Baker-Petrolite Co., Ltd.); dimer acid; dimer diol (for example, the PRIPOR series manufactured by CRODA Co., Ltd.); fatty acid inulin such as stearoyl inulin; fatty acid dextrins such as dextrin palmitate and dextrin myristate (for example, the Leopearl series manufactured by Chiba Flour Milling Co., Ltd.); glyceryl behenate eicosandioate; eicosane polyglyceryl behenate (for example, the Nomcoat series manufactured by Nisshin Oillio Co., Ltd.); amide compounds such as N-lauroyl-L-glutamic acid dibutylamide and N-(2-ethylhexanoyl)-L-glutamic acid dibutylamide (available from Ajinomoto Fine-Techno); dibenzylidene sorbitols such as 1,3:2,4-bis-O-benzylidene-D-glucitol (Gelall D, available from New Japan Chemical Co., Ltd.); and low molecular weight oil gelling agents described in JP 2005-126507 A, JP 2005-255821 A, and JP 2010-111790 A.

The gelling agent may be used alone or in combination of two or more types. These commercially available products are often mixtures including two or more types of materials, and thus, may be optionally separated and purified.

### <Photopolymerization Initiator>

The active energy ray curable inkjet ink of the present disclosure contains a photopolymerization initiator. The photopolymerization initiator may be any one that can generate active species such as radicals or cations by the energy of active energy rays and initiate polymerization of a photopolymerizable compound (monomer or oligomer). For such a photopolymerization initiator, known radical polymerization initiators, cationic polymerization initiators, base generators, and the like can be used alone or in combination of two or more, and among these, it is preferable to use a radical polymerization initiator. To obtain a sufficient curing speed, the photopolymerization initiator is preferably contained in an amount of 5% to 20% by mass relative to the total mass (100% by mass) of the inkjet ink.

Examples of the radical polymerization initiator include, but are not limited to, aromatic ketones, acylphosphine oxide compounds, aromatic onium salt compounds, organic peroxides, thio compounds (thioxanthone compounds, thiophenyl group-containing compounds, and the like), hexaarylbiimidazole compounds, ketoxime ester compounds, borate compounds, azinium compounds, metallocene compounds, active ester compounds, compounds having a carbon-halogen bond, and alkylamine compounds.

In addition to the above polymerization initiator, a polymerization accelerator (sensitizer) may also be used in combination. The polymerization accelerator is not particularly limited, but examples of the polymerization accelerator include, but are not limited to, amine compounds such as trimethylamine, methyldimethanolamine, triethanolamine, p-diethylaminoacetophenone, ethyl p-dimethylaminobenzoate, 2-ethylhexyl p-dimethylaminobenzoate, N,N-dimethylbenzylamine, and 4,4′-bis(diethylamino)benzophenone, and the content thereof may be appropriately determined depending on the polymerization initiator to be used and the amount of the polymerization initiator.

### <Color Material>

The white ink in the active energy ray curable inkjet ink set of the present disclosure may contain a color material. The colored ink in the active energy ray curable inkjet ink set of the present disclosure contains a color material. For the color material, various pigments and dyes that impart black, white, magenta, cyan, yellow, green, orange, or glossy colors such as gold or silver can be used depending on the purpose and required properties of the inkjet ink of the present disclosure. The content of the color material may be appropriately determined taking into consideration the desired color density, dispersibility in the inkjet ink, and the like, and is not particularly limited, but is preferably 0.1% to 20% by mass relative to the total mass (100% by mass) of the inkjet ink. The active energy ray curable inkjet ink of the present disclosure may be colorless and transparent without containing a color material, and in such a case, the active energy ray curable inkjet ink is suitable, for example, as an overcoat layer for protecting an image.

For the pigment, inorganic pigments or organic pigments can be used, and may be used alone, or may be used in combination of two or more types.

Examples of the inorganic pigments that can be used include, but are not limited to, carbon blacks (C.I. Pigment Black 7) such as furnace black, lamp black, acetylene black, and channel black, iron oxide, and titanium oxide.

Examples of the organic pigments include, but are not limited to, azo pigments such as insoluble azo pigments, condensed azo pigments, azo lakes, and chelate azo pigments; polycyclic pigments such as phthalocyanine pigments, perylene and perinone pigments, anthraquinone pigments, quinacridone pigments, dioxane pigments, thioindigo pigments, isoindolinone pigments, and quinophthalone pigments; dye chelates (for example, basic dye chelates, acid dye chelates, and the like); dye lakes (basic dye lakes, acid dye lakes); nitro pigments, nitroso pigments, aniline black, and daylight fluorescent pigments.

A dispersant may be further contained to improve the dispersibility of the pigment. The dispersant is not particularly limited, but examples of the dispersant include, but are not limited to, dispersants commonly used in preparing pigment dispersions, such as polymer dispersants.

Examples of the dyes that can be used include, but are not limited to, acid dyes, direct dyes, reactive dyes, and basic dyes, and the dyes may be used alone, or may be used in combination of two or more types.

### <Organic Solvent>

The active energy ray curable inkjet ink of the present invention may contain an organic solvent, but preferably does not contain an organic solvent if possible. If the composition does not contain organic solvents, especially volatile organic solvents (Volatile Organic Compounds (VOC)-free), the safety of an area where the composition is handled will be increased and it will also be possible to prevent environmental pollution. The term “organic solvent” refers to a general non-reactive organic solvent such as ether, ketone, xylene, ethyl acetate, cyclohexanone, or toluene, and should be distinguished from a reactive monomer. “Not containing” an organic solvent means that the organic solvent is substantially not contained, and the organic solvent content is preferably less than 0.1% by mass.

### <Other Components>

The active energy ray curable inkjet ink of the present disclosure may optionally contain other known components in addition to those described above. Other components other than those described above are not particularly limited, and examples of the other components include, but are not limited to, known polymerization inhibitors, leveling agents, antifoaming agents, fluorescent brightening agents, penetration enhancers, wetting agents (moisturizing agents), fixing agents, viscosity stabilizers, antifungal agents, preservatives, antioxidants, ultraviolet absorbers, chelating agents, pH adjusters, and thickeners.

### <Preparation of Active Energy Ray Curable Composition>

The active energy ray curable inkjet ink of the present disclosure can be prepared using the various components described above. The preparation means and conditions are not particularly limited, but the ink can be prepared, for example, by charging a polymerizable monomer, a pigment, a dispersant, and the like into a dispersing machine such as a ball mill, a Kitty mill, a disc mill, a pin mill, or a Dyno mill, dispersing the ingredients to prepare a pigment dispersion, and then mixing a polymerizable monomer, an initiator, a polymerization inhibitor, a surfactant, and the like into the pigment dispersion.

### <Viscosity>

The viscosity of the active energy ray curable inkjet ink of the present disclosure may be adjusted appropriately depending on the application and means of application, and is not particularly limited. For example, when an ejection means that ejections the inkjet ink from a nozzle is used, the viscosity in the range of 20° C. to 65° C., desirably the viscosity at 25° C., is preferably 3 to 40 mPa s, more preferably 5 to 15 mPa s, and particularly preferably 6 to 12 mPa s. It is particularly preferable that the viscosity range is satisfied without containing the organic solvent. The viscosity can be measured using a cone-plate type rotational viscometer, VISCOMETER TVE-22L, manufactured by Toki Sangyo Co., Ltd., with a cone rotor (1° 34′×R24) at a rotation speed of 50 rpm and with the temperature of the constant temperature circulating water appropriately set in the range of 20° C. to 65° C. VISCOMATE VM-150111 can be used to adjust the temperature of the circulating water.

### <Applications>

The application of the active energy ray curable inkjet ink of the present disclosure is not particularly limited and can be appropriately selected depending on the purpose, but is particularly suitable for use in the label packaging field where printing is provided on a film.

The active energy ray curable inkjet ink of the present disclosure can be used not only as an ink to form two-dimensional characters and images, and decorative coating films on various substrates, but also as a three-dimensional modeling material for forming three-dimensional images (three-dimensional models). This material for three-dimensional modeling may be used, for example, as a binder between powder particles used in the powder filamentation method, in which three-dimensional modeling is performed by repeatedly hardening and stacking powder layers, or may be used as a three-dimensional construction material (model material) or a support member (support material).

As a three-dimensional modeling device for forming a three-dimensional object using the active energy ray curable inkjet ink of the present disclosure, a known device can be used, and is not particularly limited. For example, the three-dimensional modeling device may include a device including a storage means, a supply means, an ejection means, an active energy ray emission means, and the like for the inkjet ink.

The present disclosure also includes a cured product obtained by curing the active energy ray curable inkjet ink, and a molded product obtained by processing a structure in which the cured product is formed on a substrate. The molded product is, for example, a product obtained by subjecting a cured product or structure formed into a sheet or film shape to molding processing such as heat stretching or punching, and is suitably used for applications requiring molding after surface decoration, such as meters and operation panel for automobiles, office automation (OA) equipment, electric and electronic equipment, cameras, and the like.

The substrate is not particularly limited and can be appropriately selected depending on the purpose. Examples of the substrate include, but are not limited to, paper, thread, fiber, fabric, leather, metal, plastic, glass, wood, ceramics, and composite materials thereof, with plastic substrates being preferred from the viewpoint of processability.

The active energy ray curable inkjet ink of the present disclosure can also be used as an active energy ray curable composition. The application of the active energy ray curable composition is not particularly limited as long as the application is in a field in which active energy ray curable materials are generally used, and can be appropriately selected depending on the purpose. Examples of the application include, but are not limited to, molding resins, paints, adhesives, insulating materials, mold release agents, coating materials, sealing materials, various resists, and various optical materials.

### [Inkjet Ink Container]

An inkjet ink container of the present disclosure refers to a container that contains active energy ray curable inkjet ink, and is suitable for use in the above-mentioned applications. For example, a container containing the active energy ray curable inkjet ink of the present disclosure can be used as an ink cartridge or an ink bottle, which eliminates the need to directly touch the ink during operations such as ink transport and ink replacement, and can prevent staining of hands, fingers, and clothing. It is possible to prevent foreign matters such as dust from getting mixed into the ink. It is sufficient that the shape, size, material, and the like of the container itself are suitable for the intended use and usage and are not particularly limited, but it is desirable that the material be a light-blocking material not transmitting light, or that the container be covered with a light-blocking sheet or the like.

### [Inkjet Ink Recording Method]

An inkjet ink recording method according to an embodiment of the present disclosure includes at least a white ink region forming step, a colored ink region forming step, and a curing step, and may optionally further include other steps.

### <White Ink Region Forming Step>

The white ink region forming step is a step of applying a white ink to a recording medium to form a white ink region. The white ink region is formed below a colored ink region, which will be described later.

### <Colored Ink Region Forming Step>

The colored ink region forming step is a step of applying a colored ink onto the white ink region to form the colored ink region. The colored ink region is formed on top of the white ink region.

### <Curing Step>

The curing step is a step in which, after the colored ink region is formed, the white ink region and the colored ink region are cured by irradiating the colored ink region with active energy rays. The ink is cured in the curing step to obtain printed matter.

### <Other Steps>

The other steps are not particularly limited as long as the other steps do not impair the effects of the present disclosure and can be appropriately selected depending on the purpose, and an example of the other steps includes, but is not limited to, an intermediate curing step.

### —Intermediate Curing Step—

The intermediate curing step is a step between the white ink region forming step and the colored ink region forming step in which the white ink region is irradiated with active energy rays to be cured.

The degree of curing in the intermediate curing step is not particularly limited and can be selected appropriately depending on the purpose. For example, the ink may be cured to the extent that the degree prevents the ink from flowing or mixing (may be referred to as “semi-curing” or “provisional curing”).

The curing in the intermediate curing step can be carried out, for example, by irradiating the white ink region with an active energy ray weaker than that in the curing step described above.

When a plurality of colored inks are used, a colored ink intermediate curing step of semi-curing the colored ink can be carried out while the colored ink regions are formed using each colored ink. When the colored ink intermediate curing step is performed, the colored ink intermediate curing step may be performed for all colored inks, or may be performed for any of the colored inks.

The white ink in the inkjet ink recording method according to an embodiment of the present disclosure contains a photopolymerizable compound and a photopolymerization initiator, and the content of the monofunctional photopolymerizable compound in the white ink is 50% by mass or more and 90% by mass or less with respect to the total amount of the photopolymerizable compound contained in the white ink. The colored ink in the inkjet ink recording method according to an embodiment of the present disclosure contains a photopolymerizable compound, a photopolymerization initiator, a color material, and a gelling agent.

For the white ink and the colored ink in the inkjet ink recording method according to an embodiment of the present disclosure, inks having the configuration similar to that of the white ink and the colored ink in the active energy ray curable inkjet ink set described above can be suitably used.

The inkjet ink recording method according to an embodiment of the present disclosure can be carried out, for example, by an image forming apparatus described below.

### <Recording Medium>

A recording medium used for recording is not particularly limited and can be appropriately selected depending on the purpose. Examples of the recording medium include, but are not limited to, transparent films such as a PET film and an OPP film.

### <Applications>

The inkjet ink recording method of the present disclosure is not particularly limited and can be appropriately selected depending on the purpose, but is particularly suitable for use in the label packaging field where printing is provided on a film.

### [Printed Material]

The present disclosure also relates to printed matter obtained by recording using the inkjet ink recording method according to one embodiment of the present disclosure.

### [Image Forming Method and Forming Apparatus]

The image forming method according to an embodiment of the present disclosure includes at least an emission step of emitting active energy rays to cure the active energy ray curable inkjet ink according to an embodiment of the present disclosure. An image forming apparatus according to an embodiment of the present disclosure includes an emission means that emits active energy rays, and a storage unit that stores the active energy ray curable inkjet ink according to an embodiment of the present disclosure, and the storage unit may store the container. The image forming method and the image forming apparatus may include an ejection step or an ejection means for ejecting the active energy ray curable inkjet ink. The method for ejecting the inkjet ink is not particularly limited, but examples of the method include, but are not limited to, a continuous ejection type method and an on-demand type method. Examples of the on-demand type method include, but are not limited to, a piezo type method, a thermal type method, and an electrostatic type method.

The drawing illustrates an example of an image forming apparatus including an inkjet ejection means. Ink is ejected onto a recording medium 22 supplied from a supply roll 21, by color printing units 23a, 23b, 23c, 23d, and 23e, each of which includes an ink cartridge and an ejection head for active energy ray curable inks of each of white, yellow, magenta, cyan, and black. Thereafter, the ink is cured by irradiating the ink with active energy rays from light sources 24a, 24b, 24c, 24d, and 24e for curing the ink to form a color image. Next, the recording medium 22 is transported to a processing unit 25 and printed matter take-up roll 26. Each of the color printing units 23a, 23b, 23c, 23d, and 23e may include a heating mechanism so that the ink is liquefied in an ink ejection unit. A mechanism for cooling the recording medium to about room temperature by contact or non-contact may be optionally provided. The inkjet ink recording method can be either a serial method in which a head is moved to eject ink onto a recording medium moving intermittently according to the width of the ejection head, or a line method in which the recording medium is moved continuously and ink is ejected onto a recording medium from a head held at a fixed position.

The recording medium 22 is not particularly limited, but examples of the recording medium 22 include, but are not limited to, paper, film, metal, and composite materials thereof, and may be in the form of a sheet. The recording medium 2 may be configured to allow only single-sided printing, or may be configured to allow double-sided printing.

The irradiation of active energy rays from the light sources 24a, 24b, 24c, and 24d may be weakened or omitted, and after providing printing with multiple colors, the active energy rays may be emitted from the light source 24e. This allows for energy savings and cost reduction.

Recorded materials (also referred to as “printed materials”) in which recording is provided using the ink of the present disclosure include not only those printed on smooth surfaces such as ordinary paper or resin film, but also those printed on uneven printing surfaces and those printed on printing surfaces formed of various materials such as metal or ceramic. If two-dimensional images are stacked, it is possible to form an image with a partially three-dimensional appearance (a two and three-dimensional image) or a three-dimensional object.

### EXAMPLES

Hereinafter, examples of embodiments of the present disclosure will be described more specifically with reference to examples and comparative examples, but the present disclosure is not limited to such examples and comparative examples.

### (Production of White Pigment Dispersion A)

The following two compounds were placed in a stainless steel beaker. The mixture was stirred for one hour while being heated on a hot plate at 65° C.
52 parts by mass of phenoxyethyl acrylate (Viscoat 192, manufactured by Osaka Organic Chemical Industry Co., Ltd.)
8 parts by mass of Dispersant (BYKJET-9151: manufactured by BYK Corporation, “BYKJET” is a registered trademark of BYK Corporation)

After cooling the mixture to room temperature, 40 parts by mass of titanium oxide (TCR-52; manufactured by Sakai Chemical Industry Co., Ltd.) having 200 nm of an average particle size was added to the resultant mixture, and the mixture was placed in a glass bottle together with 220 g of zirconia beads with 0.5 mm in diameter and sealed. This was dispersed in a paint shaker for five hours, after which the zirconia beads were removed to obtain a white pigment dispersion A.

### (Production of White Pigment Dispersion B)

The following two compounds were placed in a stainless steel beaker. The mixture was stirred for one hour while being heated on a hot plate at 65° C.
52 parts by mass of tripropylene glycol diacrylate (Miramer M200: manufactured by Miwon Co., Ltd., “Miramer” is a registered trademark of Miwon Co., Ltd.)
8 parts by mass of Dispersant (BYKJET-9151: manufactured by BYK Corporation)

After cooling the mixture to room temperature, 40 parts by mass of titanium oxide (TCR-52; manufactured by Sakai Chemical Industry Co., Ltd.) having 200 nm of an average particle size was added to the resultant mixture, and the mixture was placed in a glass bottle together with 220 g of zirconia beads with 0.5 mm in diameter and sealed. This was dispersed in a paint shaker for five hours, after which the zirconia beads were removed to obtain a white pigment dispersion B.

### (Production of Colored Pigment Dispersion)

A black pigment dispersion A, a cyan pigment dispersion A, a magenta pigment dispersion A, and a yellow pigment dispersion A were produced as follows.

The following two compounds were placed in a stainless steel beaker. The mixture was stirred for one hour while being heated on a hot plate at 65° C.
71 parts by mass of dipropylene glycol diacrylate (APG-100, manufactured by Shin-Nakamura Chemical Co., Ltd., molecular weight 242)
9 parts by mass of dispersant (BYKJET-9151: manufactured by BYK Corporation)

After cooling to room temperature, 20 parts by mass of one of the following pigments was added to the mixture, and the mixture was placed in a glass bottle together with 200 g of zirconia beads with 0.5 mm in diameter and sealed. This was dispersed in a paint shaker for the following hours, after which the zirconia beads were removed to obtain a colored pigment dispersion.
Black pigment dispersion A: Pigment Black 7 (manufactured by Mitsubishi Chemical, #52), dispersion time: five hours
Cyan pigment dispersion A: Pigment Blue 15:4 (manufactured by Dainichi Seika Chemicals, Chromofine Blue 6332JC), dispersion time: four hours
Magenta pigment dispersion A: Mixed crystal of Pigment Violet 19 and Red 202 (manufactured by BASF CINQUASIA MAGENTA RT-355D), dispersion time: six hours
Yellow pigment dispersion A: Pigment Yellow 185 (manufactured by BASF, D1155), dispersion time: six hours

### (Preparation of White Inks 1 to 4, Black Inks 1 to 3, Cyan Ink 1, Magenta Ink 1, and Yellow Ink 1)

The raw materials were mixed according to the formulations shown in Tables 1 to 3 below, and an ink mixture was obtained using a Three-One Motor. Thereafter, the ink was filtered using a capsule filter with an absolute filtration accuracy of 1.0 m, and filled into a clean bottle to obtain various inks. The blending amounts in Tables 1 to 3 are expressed in % by mass.

The raw materials used other than the pigment dispersion are as follows: These are used as an example only.

### [Monofunctional Monomer]

Phenoxyethyl acrylate (hereinafter referred to as “PEA”), manufactured by Osaka Organic Chemical Industry Co., Ltd.
Isobornyl acrylate (hereinafter referred to as “IBOA”), manufactured by Osaka Organic Chemical Industry Ltd.
Acryloylmorpholine (hereinafter referred to as “ACMO”), manufactured by KJ Chemicals
   <Photopolymerizable Compounds Other than Monofunctional Monomers>

### —Polyfunctional Monomer—

Polyethylene glycol (400) diacrylate (hereinafter may be referred to as “PEG400DA”), manufactured by Daiichi Kogyo Seiyaku Co., Ltd.
Polyethylene glycol (600) diacrylate (hereinafter may be referred to as “PEG600DA”), manufactured by Daiichi Kogyo Seiyaku Co., Ltd.
Tripropylene glycol diacrylate (hereinafter may be referred to as “TPGDA”), manufactured by Osaka Organic Chemical Industry Co., Ltd.
Trimethylolpropane (EO) 9 triacrylate (hereinafter may be referred to as “TMP (EO) 9TA”), manufactured by Shin-Nakamura Chemical Co., Ltd.
Trimethylolpropane (PO) 3 triacrylate (hereinafter may be referred to as “TMP (EO) 3TA”), manufactured by Shin-Nakamura Chemical Co., Ltd.
Tricyclodecane dimethanol diacrylate (hereinafter may be referred to as “R-684”), manufactured by Nippon Kayaku Co., Ltd.

### —Oligomer—

CN963J85 (hereinafter may be referred to as “CN963”), manufactured by Sartomer
CN2273, manufactured by Sartomer

### [Photopolymerization Initiator]

Omnirad TPO (hereinafter may be referred to as “TPO”), manufactured by IGM Resins
Omnirad 819, manufactured by IGM Resins

### [Polymerization Inhibitor]

Irgastab UV-10 (hereinafter may be referred to as “UV-10”), manufactured by BYK Corporation

### [Gelling Agent]

Behenyl behenate (hereinafter may be referred to as “M-2222SL”), manufactured by NOF Corporation
Stearyl stearate (hereinafter may be referred to as “M-9676”), manufactured by NOF Corporation
Cetyl myristate (hereinafter may be referred to as “sperm acetyl”), manufactured by NOF Corporation

### [Surfactant]

BYK307, manufactured by BYK Corporation

The dynamic surface tension (15 milliseconds (ms) and 1,500 ms) of the prepared ink at 25° C. was measured using a portable dynamic surface tensiometer, Dynotester (manufactured by Yamato Scientific Co., Ltd.). A difference (mN/m) between the dynamic surface tension at 25° C. for 15 ms and the dynamic surface tension at 25° C. for 1,500 ms is shown in Tables 1 to 3.

TABLE 1

| | | White | White | White | White |
|---|---|---|---|---|---|
| | | Ink 1 | Ink 2 | Ink 3 | Ink 4 |
| Monofunctional | PEA | 16 | 16 | 16 | — |
| Monomer | IBOA | 19 | 20 | 20.05 | — |
| | ACMO | 7.5 | 7.5 | 7.5 | — |
| Polyfunctional | PEG400DA | — | — | — | 10 |
| Monomer | PEG600DA | — | — | — | 10 |
| | TPGDA | — | — | — | 10 |
| | TMP(EO)9TA | — | — | — | 12.8 |
| | TMP(PO)3TA | — | — | — | 20 |
| | R-684 | 4 | 4 | 4 | — |
| Oligomer | CN963 | 5 | 5 | 5 | — |
| | CN2273 | — | — | — | 8 |
| Polymerization | TPO | 5 | 5 | 5 | — |
| Initiator | Omnirad 819 | 1 | 1 | 1 | 3 |
| Polymerization | UV-10 | 0.15 | 0.15 | 0.15 | 0.15 |
| Inhibitor | | | | | |
| Gelling Agent | M-2222SL | 0.2 | — | — | 0.2 |
| | M-9676 | 0.4 | — | — | 0.4 |
| | SPERM ACETY | 0.4 | — | — | 0.4 |
| Surfactant | BYK307 | 0.05 | 0.05 | — | 0.05 |
| Pigment | White Pigment | 41.3 | 41.3 | 41.3 | — |
| Dispersant | Dispersant A | | | | |
| | White Pigment | — | — | — | 25 |
| | Dispersant B | | | | |

| | | | | |
|---|---|---|---|---|
| Difference in dynamic surface tension | 4 | 4 | 1 | 4 |
| between 15 ms and 1500 ms (mN/m) | | | | |

TABLE 2

| | | Black | Cyan | Magenta | Yellow |
|---|---|---|---|---|---|
| | | Ink 1 | Ink 1 | Ink 1 | Ink 1 |
| Monofunctional | PEA | — | — | — | — |
| Monomer | IBOA | — | — | — | — |
| | ACMO | — | — | — | — |
| Polyfunctional | PEG400DA | 10 | 10 | 10 | 10 |
| Monomer | PEG600DA | 10 | 10 | 10 | 10 |
| | TPGDA | 15 | 15 | 15 | 15 |
| | TMP(EO)9TA | 18 | 18 | 18 | 18 |
| | TMP(PO)3TA | 25 | 25 | 25 | 25 |
| | R-684 | — | — | — | — |
| Oligomer | CN963 | — | — | — | — |
| | CN2273 | 5 | 5 | 5 | 5 |
| Polymerization | TPO | — | — | — | — |
| Initiator | Omnirad 819 | 3 | 3 | 3 | 3 |
| Polymerization | UV-10 | 0.15 | 0.15 | 0.15 | 0.15 |
| Inhibitor | | | | | |
| Gelling Agent | M-2222SL | 0.5 | 0.5 | 0.5 | 0.5 |
| | M-9676 | 0.4 | 0.4 | 0.4 | 0.4 |
| | SPERM ACETY | 0.4 | 0.4 | 0.4 | 0.4 |
| Surfactant | BYK307 | 0.05 | 0.05 | 0.05 | 0.05 |
| Pigment | Black Pigment | 12.5 | — | — | — |
| Dispersant | Dispersant A | | | | |
| | Cyan Pigment | — | 12.5 | — | — |
| | Dispersant A | | | | |
| | Magenta Pigment | — | — | 12.5 | — |
| | Dispersant A | | | | |
| | Yellow Pigment | — | — | — | 12.5 |
| | Dispersant A | | | | |

| | | | | |
|---|---|---|---|---|
| Difference in dynamic surface tension | 4 | 4 | 4 | 4 |
| between 15 ms and 1500 ms (mN/m) | | | | |

TABLE 3

| | | Black | Black |
|---|---|---|---|
| | | Ink 2 | Ink 3 |
| Monofunctional | PEA | — | — |
| Monomer | IBOA | — | — |
| | ACMO | — | — |
| Polyfunctional | PEG400DA | 10 | 10 |
| Monomer | PEG600DA | 10 | 10 |
| | TPGDA | 15 | 15 |
| | TMP(EO)9TA | 18.05 | 19.3 |
| | TMP(PO)3TA | 25 | 25 |
| | R-684 | — | — |
| Oligomer | CN963 | — | — |
| | CN2273 | 5 | 5 |
| Polymerization | TPO | — | — |
| Initiator | Omnirad 819 | 3 | 3 |
| Polymerization | UV-10 | 0.15 | 0.15 |
| Inhibitor | | | |
| Gelling Agent | M-2222SL | 0.5 | — |
| | M-9676 | 0.4 | — |
| | SPERM ACETY | 0.4 | — |
| Surfactant | BYK307 | — | 0.05 |
| Pigment | Black Pigment | 12.5 | 12.5 |
| Dispersant | Dispersant A | | |

| | | |
|---|---|---|
| Difference in dynamic surface | 1 | 4 |
| tension between 15 ms and 1500 ms | | |
| (mN/m) | | |

### Examples 1 to 11, Comparative Examples 1 to 3

Printed materials were produced using the inks listed in the “Implementation Configuration” column of Tables 4 to 7 below, using a one-pass printer including a Ricoh MH5320 head illustrated in the drawing. Specifically, a solid image of each color ink was printed at 600 dpi in the main scanning direction, 600 dpi in the sub-scanning direction, a droplet size of 15 pL, and an ejection frequency of 30 kHz, and irradiated with a UV-LED having a wavelength of 395 nm to produce printed matter. It is noted that “WoW” and “WoD” in the “Printing Process” section of the “Implementation Configuration” column in Tables 4 to 7 below indicate that the printing process was carried out as follows.

For the “WoW”, an image was formed using the white ink, followed by an image formed using a colored ink, and then the ink was cured by irradiating the ink with light (395 nm, 16 W/cm²) from an LED lamp (manufactured by Phoseon Technology). The distance from the LED lamp to the recording medium surface was 20 mm, and the recording medium conveyance speed was 1.2 m/s (light intensity: 300 mJ/cm²). The light intensity was measured using an ultraviolet integrating light meter (UV Power Pack, manufactured by Noblelight).

In this example, the printing process was carried out as described above. However, the printing process can also be carried out by including, for example, a step of installing UV-LED lamps between the ejection heads of the colored inks, emitting UV with an integrated light intensity of 100 mJ/cm² or less, and semi-curing each of the various inks after forming an image using the various inks, and a step of emitting UV with an integrated light intensity of 300 mJ/cm² or more after forming an image using all of the inks, and curing the inks.

In the “WoD”, a UV-LED lamp was placed between the ejection head for the white ink and the ejection head for the colored ink. After forming an image using the white ink, the white ink was semi-cured by emitting UV with an integrated light intensity of 100 mJ/cm² or less. After forming an image using all inks, including the colored ink, the ink was cured by emitting UV with an integrated light intensity of 300 mJ/cm² or more.

In this example, the printing process was carried out as described above. However, the printing process can also be carried out by including, for example, a step of installing UV-LED lamps between the ejection heads of the colored inks, emitting UV with an integrated light intensity of 100 mJ/cm² or less, and semi-curing the various inks after forming an image using the various inks.

### [Quality Evaluation]

The produced printed matters were evaluated for “film adhesion”, “gloss”, “color development”, and “colored ink bleeding” as follows. The results are shown in Tables 4 to 7.

### <Film Adhesion>

The produced printed matters were subjected to a cross-cut test in accordance with JIS K5600-5-6 and evaluated according to the following criteria. Good and Fair are passing marks.

### —Evaluation Criteria—

Good: Classification 0 or 1
Fair: Classification 2 or 3
Poor: Classification 4 or 5

### <Gloss>

The glossiness of the produced printed matters was measured using a Micro Trigloss Meter manufactured by BYK-Gardner GmbH for gloss of the produced printed matters. An image was evaluated at five points, and the average value was taken as the glossiness. The image was evaluated based on the glossiness value at 600 according to the following evaluation criteria. Excellent, Good, and Fair are passing marks.

### —Evaluation Criteria—

Excellent: Glossiness value at 600 is 7.0 or more
Good: Glossiness value at 600 is 5.5 or more and less than 7.0
Fair: Glossiness value at 60° is 4.0 or more and less than 5.5
Poor: Glossiness value at 600 is less than 4.0

### <Color Development>

The colored ink images on the produced printed matters were evaluated for a saturation value measured using an X-Rite 939 according to the following criteria. Good and Fair are passing marks.

### —Evaluation Criteria—

### Black Ink

Good: OD is 1.3 or more
Fair: OD is 1.2 or more and less than 1.3
Poor: OD is less than 1.2

### Cyan Ink

Good: Saturation is 55 or more
Fair: Saturation is 45 or more and less than 55
Poor: Saturation is less than 45

### Magenta Ink

Good: Saturation is 70 or more
Fair: Saturation is 60 or more and less than 70
Poor: Saturation is less than 60

### Yellow Ink

Good: Saturation is 85 or more
Fair: Saturation is 80 or more and less than 85
Poor: Saturation is less than 80

### <Colored Ink Bleeding>

White ink serving as a base layer was printed, and then a 100% solid area of yellow ink and a 100% solid area of black ink were printed adjacent to each other. The adjacent areas of the yellow ink and the black ink were visually observed and evaluated according to the following criteria. Good and Fair are passing marks.

### —Evaluation Criteria—

Good: No visible bleeding
Fair: Slight bleeding is observed
Poor: Adjacent areas are blurred and unclear

TABLE 4

| | | Exam- | Exam- | Exam- | Exam- |
|---|---|---|---|---|---|
| | | ple 1 | ple 2 | ple 3 | ple 4 |
| Implementation | White Ink | White | White | White | White |
| Configuration | | Ink 1 | Ink 2 | Ink 3 | Ink 3 |
| | Colored Ink | Black | Black | Black | Black |
| | | Ink 1 | Ink 1 | Ink 1 | Ink 2 |
| | Printing | WoW | WoW | WoW | WoW |
| | Process | | | | |
| Quality | Film | Good | Good | Good | Good |
| Evaluation | Adhesion | | | | |
| Result | Gloss | Fair | Good | Good | Excellent |
| | Color | Fair | Fair | Good | Good |
| | Development | | | | |
| | Colored Ink | Good | Good | Good | Good |
| | Bleeding | | | | |

TABLE 5

| | | Exam- | Exam- | Exam- | Exam- |
|---|---|---|---|---|---|
| | | ple 5 | ple 6 | ple 7 | ple 8 |
| Implementation | White Ink | White | White | White | White |
| Configuration | | Ink 1 | Ink 2 | Ink 3 | Ink 3 |
| | Colored Ink | Black | Black | Black | Black |
| | | Ink 1 | Ink 1 | Ink 1 | Ink 2 |
| | Printing | WoD | WoD | WoD | WoD |
| | Process | | | | |
| Quality | Film | Good | Good | Good | Good |
| Evaluation | Adhesion | | | | |
| Result | Gloss | Fair | Good | Good | Excellent |
| | Color | Good | Good | Excellent | Excellent |
| | Development | | | | |
| | Colored Ink | Good | Good | Good | Good |
| | Bleeding | | | | |

TABLE 6

| | | Example 9 | Example 10 | Example 11 |
|---|---|---|---|---|
| Implementation | White Ink | White | White | White |
| Configuration | | Ink 1 | Ink 1 | Ink 1 |
| | Colored Ink | Cyan | Magenta | Yellow |
| | | Ink 1 | Ink 1 | Ink 1 |
| Quality | Printing | WoD | WoD | WoD |
| Evaluation | Process | | | |
| Result | Film | Good | Good | Good |
| | Adhesion | | | |
| | Glow | Fair | Fair | Fair |
| | Color | Good | Good | Good |
| | Development | | | |
| | Colored Ink | Good | Good | Good |
| | Bleeding | | | |

TABLE 7

| | | Comparative | Comparative | Comparative |
|---|---|---|---|---|
| | | Example 1 | Example 2 | Example 3 |
| Implementation | White Ink | White | White | White |
| Configuration | | Ink 4 | Ink 1 | Ink 4 |
| | Colored Ink | Black | Black | Black |
| | | Ink 1 | Ink 3 | Ink 3 |
| | Printing | WoW | WoW | WoW |
| | Process | | | |
| Quality | Film | Poor | Good | Poor |
| Evaluation | Adhesion | | | |
| Result | Gloss | Fair | Fair | Fair |
| | Color | Fair | Fair | Fair |
| | Development | | | |
| | Colored Ink | Good | Poor | Poor |
| | Bleeding | | | |

From the above results, it was confirmed that, according to one aspect of the present disclosure, in providing printing with an active energy ray curable inkjet ink on a recording medium, the adhesion of the white ink to the recording medium, the gloss of the printed matter, and the color development of the colored ink could be improved, and bleeding of the colored ink could be suppressed.

Aspects of the embodiments of the present disclosure are, for example, as follows.

### Aspect 1.

An active energy ray curable inkjet ink set including a white ink and a colored ink, in which the white ink contains a photopolymerizable compound and a photopolymerization initiator, a content of a monofunctional photopolymerizable compound in the white ink is 50% by mass or more and 90% by mass or less with respect to a total amount of the photopolymerizable compound contained in the white ink, and the colored ink contains a photopolymerizable compound, a photopolymerization initiator, a color material, and a gelling agent.

### Aspect 2.

The active energy ray curable inkjet ink set according to Aspect 1, in which the white ink is substantially free of a gelling agent.

### Aspect 3.

The active energy ray curable inkjet ink set according to Aspect 1 or 2, in which a difference in the white ink between a dynamic surface tension at 25° C. for 15 ms and a dynamic surface tension at 25° C. for 1,500 ms is 0 mN/m or more and 3.0 mN/m or less.

### Aspect 4.

The active energy ray curable inkjet ink set according to any one of Aspects 1 to 3, in which a difference in the colored ink between a dynamic surface tension at 25° C. for 15 ms and a dynamic surface tension at 25° C. for 1,500 ms is 0 mN/m or more and 3.0 mN/m or less.

### Aspect 5.

An inkjet ink recording method including a white ink region forming step of applying a white ink to a recording medium to form a white ink region, a colored ink region forming step of applying a colored ink onto the white ink region to form a colored ink region, and a curing step of irradiating the white ink region and the colored ink region with active energy rays to cure the white ink region and the colored ink region after the colored ink region forming step, in which the white ink contains a photopolymerizable compound and a photopolymerization initiator, a content of a monofunctional photopolymerizable compound in the white ink is 50% by mass or more and 90% by mass or less with respect to a total amount of the photopolymerizable compound contained in the white ink, and the colored ink contains a photopolymerizable compound, a photopolymerization initiator, a color material, and a gelling agent.

### Aspect 6.

The inkjet ink recording method according to Aspect 5, further including an intermediate curing step of irradiating the white ink region with active energy rays to cure the white ink region, between the white ink region forming step and the colored ink region forming step.

### Aspect 7.

The inkjet ink recording method according to Aspect 5 or 6, in which the white ink is substantially free of a gelling agent.

### Aspect 8.

The inkjet ink recording method according to any one of Aspects 5 to 7, in which a difference in the white ink between a dynamic surface tension at 25° C. for 15 ms and a dynamic surface tension at 25° C. for 1,500 ms is 0 mN/m or more and 3.0 mN/m or less.

### Aspect 9.

The inkjet ink recording method according to any one of Aspects 5 to 8, in which a difference in the colored ink between a dynamic surface tension at 25° C. for 15 ms and a dynamic surface tension at 25° C. for 1,500 ms is 0 mN/m or more and 3.0 mN/m or less.

### Aspect 10.

Printed matter obtained by recording using the inkjet ink recording method according to any one of Aspects 5 to 9.

The active energy ray curable inkjet ink set according to any one of Aspect 1 to Aspect 4, the inkjet ink recording method according to any one of Aspects 5 to 9, or the printed matter according to Aspect 10 can solve the various problems encountered in the past and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An active energy ray curable inkjet ink set comprising:
a white ink containing:
a photopolymerizable compound containing a monofunctional photopolymerizable compound in an amount of 50% by mass or more and 90% by mass or less of the photopolymerizable compound contained in the white ink; and
a photopolymerization initiator; and
a colored ink containing:
a photopolymerizable compound;
a photopolymerization initiator;
a color material; and
a gelling agent.

2. The active energy ray curable inkjet ink set according to claim 1, wherein the white ink is substantially free of a gelling agent.

3. The active energy ray curable inkjet ink set according to claim 1, wherein a difference in the white ink between a dynamic surface tension at 25° C. for 15 ms and a dynamic surface tension at 25° C. for 1,500 ms is 0 mN/m or more and 3.0 mN/m or less.

4. The active energy ray curable inkjet ink set according to claim 1, wherein a difference in the colored ink between a dynamic surface tension at 25° C. for 15 ms and a dynamic surface tension at 25° C. for 1,500 ms is 0 mN/m or more and 3.0 mN/m or less.

5. An inkjet ink recording method comprising:
applying the white ink of the active energy ray curable inkjet ink set according to claim 1 to a recording medium to form a white ink region;
applying the colored ink of the active energy ray curable inkjet ink set onto the white ink region to form a colored ink region; and
irradiating the white ink region and the colored ink region with active energy rays to cure the white ink region and the colored ink region, after the applying of the colored ink to form the colored ink region.

6. The inkjet ink recording method according to claim 5, further comprising irradiating the white ink region with active energy rays to cure the white ink region, between the applying of the white ink to form the white ink region and the applying of the colored ink to form the colored ink region.

7. The inkjet ink recording method according to claim 5, wherein the white ink is substantially free of a gelling agent.

8. The inkjet ink recording method according to claim 5, wherein a difference in the white ink between a dynamic surface tension at 25° C. for 15 ms and a dynamic surface tension at 25° C. for 1,500 ms is 0 mN/m or more and 3.0 mN/m or less.

9. The inkjet ink recording method according to claim 5, wherein a difference in the colored ink between a dynamic surface tension at 25° C. for 15 ms and a dynamic surface tension at 25° C. for 1,500 ms is 0 mN/m or more and 3.0 mN/m or less.

10. Printed matter obtained by recording using the inkjet ink recording method according to claim 5.
